(19) United States
(12) Patent Application Publication
(10) Pub. No.: US 2010/0106748 A1
(43) Pub. Date: Apr. 29, 2010

(54) METHOD AND SYSTEM FOR LOGGING AND STORING HETEROGENEOUS COMMUNICATION SESSIONS

(75) Inventors: Paul T. Schultz, Colorado Springs, CO (US); Robert A. Sartini, Colorado Springs, CO (US); Martin W. McKee, Herndon, VA (US)

Correspondence Address: VERIZON;PATENT MANAGEMENT GROUP, 1320 North Court House Road, 9th Floor, ARLINGTON, VA, 22201-2909, US

(73) Assignee: Verizon Business Network Services Inc., Ashburn, VA (US)

(21) Appl. No.: 12/256,664

(22) Filed: Oct. 23, 2008

(51) Int. Cl. G06F 17/30

(52) U.S. Cl. 707/803; 707/E17.044

(57) ABSTRACT

An approach is provided for creating a workspace for automatically logging and storing heterogeneous communication sessions and for accessing this workspace from a user-designated environment.

### BACKGROUND INFORMATION

Modern communications systems offer a wide variety of mechanisms and devices for conducting a communication session. As a result, users often find themselves engaging in related communication sessions that take place in many different forms over different communication devices (i.e., heterogeneous communications). With the increasing sophistication and adoption of communication technologies, users can move from one form of communication to another when addressing a particular topic or issue. For example, a user receives an E-mail message about an urgent matter and follows up on the E-mail message with a telephone call. After the telephone call, the user conducts a video conference to discuss the matter further. Unfortunately, the ease of transitioning between different forms of communication can also make it difficult for the user to keep track of all related communications. That is, the user typically would have to track all of the various forms of communications individually to have a complete record of how the user handled the urgent matter.

Another problem the user may face is the difficulty of referencing all of the various forms of communications through one designated communication device. The user in the situation of the example above may find it difficult or even impossible to access the full history of communication sessions without having access to all previously used communication devices. Traditional communications systems have not provided the ability to automatically track all related communication sessions when these communication sessions originate on different devices.

In parallel, communications service providers are continually challenged to develop new services and features to remain competitive and to develop new sources of revenue.

Therefore, there is a need for an approach that provides for automated logging and retrieval of heterogeneous communication sessions from any user-designated communication device, while creating a new source of revenue for communication service providers.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of creating a workspace and then logging and storing heterogeneous communication sessions within the workspace, according to an exemplary embodiment;

FIG. 2 is a diagram of the components of a workspace manager platform, according to an exemplary embodiment;

FIG. 3 is a flowchart of a process for creating a workspace and then logging heterogeneous communication sessions within the workspace, according to an exemplary embodiment;

FIG. 4 is a flowchart of a process for recording a communication session to a workspace, according to an exemplary embodiment;

FIG. 5 is a flowchart of a process for re-homing a workspace to an environment specified by the user, according to an exemplary embodiment;

FIG. 6 is a flowchart of a process for allowing access to a workspace by another user, according to an exemplary embodiment;

FIG. 7 is a flowchart of a process for obtaining supplemental information about a workspace or communication session, according to an exemplary embodiment;

FIG. 8 is a flowchart of a process for receiving a command from a user to organize, annotate, or search a workspace, according to an exemplary embodiment;

FIG. 9 is a flowchart of a process for delivering a workspace to an application, according to an exemplary embodiment;

FIG. 10 is a flowchart of a process for using the workspace manager to record a communication session to a workspace from a user's perspective, according to an exemplary embodiment;

FIG. 11 is a flowchart of a process for using a portal to access the functions of the workspace manager from a user's perspective, according to an exemplary embodiment;

FIGS. 12A-12C depict exemplary graphical user interfaces (GUIs) for using a portal to access the functions of the workspace manager, according to various embodiments of the present invention; and

FIG. 13 is a diagram of a computer system that can be used to implement various exemplary embodiments.

### DESCRIPTION OF THE PREFERRED EMBODIMENT

A preferred apparatus, method, and system for logging and storing heterogeneous communication sessions are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

It is contemplated that the various exemplary embodiments described herein have applicability to any device capable of communicating over a network, such as a multimedia device, a wireless application protocol (WAP) enabled cellular telephone, a home communication terminal (HCT), a digital home communication terminal (DHCT), landline connected to a Public Switched Telephone Network (PSTN), a personal digital assistant (PDA), a television, and/or a personal computer (PC), as well as other like technologies and customer premises equipment (CPE).

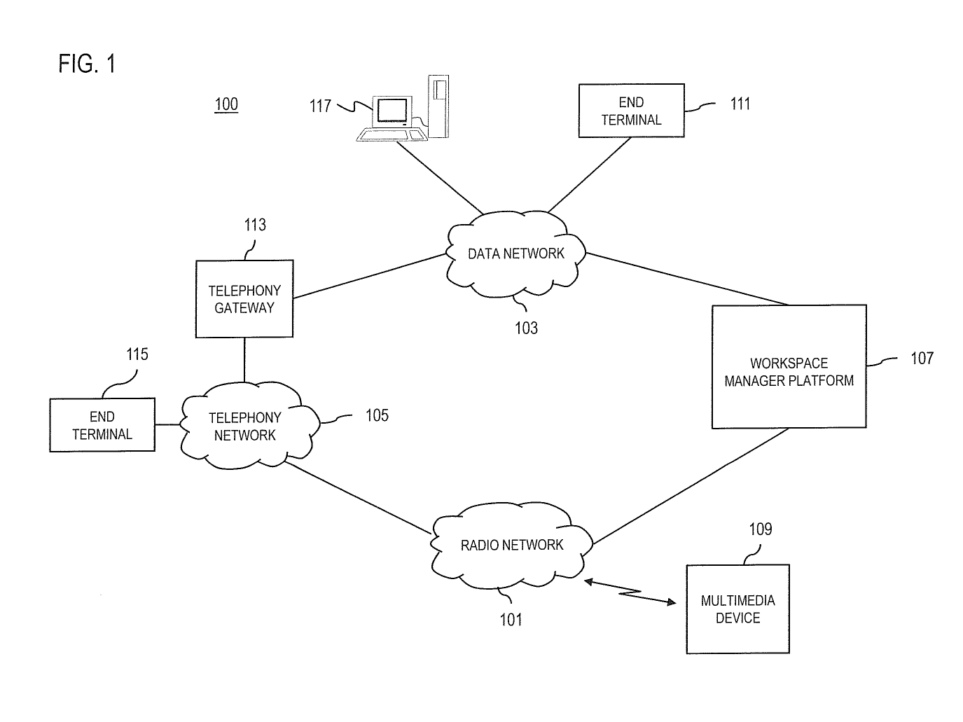

FIG. 1 is a diagram of a system capable of creating a workspace and then logging and storing heterogeneous communication sessions within the workspace, according to an exemplary embodiment. For the purposes of illustration, a mechanism for logging and storing heterogeneous communication sessions is described with respect to a communication system 100 that includes a radio network 101, a data network 103, and a telephony network 105. These networks 101-105 can support various communication sessions, e.g., voice, data, video, E-mail, etc. A workspace manager platform 107 provides a capability to log and/or store these heterogeneous communication sessions. As shown, the platform 107 resides within the network side. In addition (or alternatively), the workspace manager platform 107 may reside within customer premises equipment (CPE) (not shown). Specifically, the workspace manager platform 107 enables automated and efficient organization of a user's heterogeneous communication sessions by creating a workspace (e.g., an electronic folder) for logging and storing the user's communication sessions for later reference and/or retrieval. The heterogeneous communication sessions may occur in different formats, over different communication devices, and at varying times.

It is contemplated that the radio network 101 may be, for example, a cellular network and may employ various technologies including code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like. In addition, the data network 103 may be any local area network (LAN), metropolitan area network (MAN), wide area network (WAN), the Internet, or any other suitable packet-switched network, such as a commercially owned, proprietary packet-switched network, e.g., a proprietary cable or fiber-optic network.

As discussed above, a user often employ many different forms of communications (e.g., voice communication, text-based communication, video communication, multimedia conferencing, or a combination thereof) on many different devices (e.g., home telephone, mobile telephone, work computer, etc.) to execute a particular task or assignment. While having a wide variety of communication options can often be helpful, this poses a challenge when a comprehensive record spanning all the various forms of all communications is needed.

A typical scenario involving the use of numerous communication means is as follows. The user receives a business-related text message on a mobile telephone while at home. The user calls the sender of the E-mail from a home telephone line and determines the need for an immediate video conference. The user conducts the video conference from a home television and leaves for the office after completing the conference. On route to the office, the user makes several related calls from the user's mobile telephone and receives additional related E-mails on the user's E-mail device. The user arrives at the office and wants a “workspace” of all the related communication sessions available via the user's work computer. In this case, the workspace would include all the user's activities (i.e., text message, home phone originated call, video conference conducted on home television, E-mail messages, and mobile phone calls) for the business-related issue the user is working on. However, traditionally, little attention has been afforded to giving the user the capability to organize, correlate, and recall heterogeneous communications. Thus, it is apparent that improvements are needed to enable the user to log related heterogeneous communication sessions within a central workspace to facilitate obtaining a comprehensive history of related communications. For instance, the user may want to review the history of communication sessions through a work personal computer even though one or more of the communication sessions may have taken place on any number of devices such as a cellular telephone, a video terminal, or a home telephone.

To address this problem, the workspace manager platform 107 creates one or more workspaces, logs the user's communication sessions into these workspaces, and presents the workspaces to the user on a user-designated communication device. In exemplary embodiments, the workspace manager platform 107 may also be configured to record the communication sessions into an appropriate workspace. Once the user's communication sessions are logged and/or stored in workspaces, the platform 107 may leverage the resources of the communications network to, for instance, convert the communication sessions into a searchable format, obtain supplemental information about the communication sessions, re-home the workspace (e.g., by translating the communication sessions stored within the workspace) to other environments or communication devices, control access to the workspace, and deliver the communication sessions stored in a workspace to other applications. In this way, the platform 107 enables the user to easily create a history of related communication sessions and access the history from any communication device.

As seen in FIG. 1, the workspace manager platform 107 is connected to a multimedia device 109 (e.g., mobile device, or handset) via a cellular gateway (not shown) over a radio network 101. The multimedia device 109 may, for instance, provide access to the services of the workspace manager platform 107. The workspace manager platform 107 also has connectivity to a data network 103 that supports an end terminal 111. End terminal 111 may be any computing device (e.g., Personal Digital Assistant (PDA), personal computer, laptop, etc.) or communication device (e.g., a Voice over Internet Protocol (VoIP) station, a video conferencing terminal, a digital home communication terminal (DHCT), a television set-top box (STB)) capable of providing access to the services of the workspace manager platform 107 and supporting communication sessions over data network 103.

In addition, the workspace manager platform 107 has connectivity to a telephony network 105 through data network 103 and a telephony gateway 113. In this example, the telephony network 105 can serve an end terminal 115, which may provide access to the services of the workspace manager platform 107 and include a voice station for initiating a voice call to other end terminals capable of supporting the voice call. End terminal 115 may, for example, include a home communication terminal (HCT), and other telephonic devices, with connectivity to a Public Switched Telephone Network (PSTN), which may be a part of the telephony network 105.

The data network 103 additionally permits a host 117 to access workspace manager platform 107 functions and preferences via a graphical user interface (GUT) such as a browser application or any web-based application for multimedia device 109, end terminal 111, and/or end terminal 115. Under one scenario, it is contemplated that a user can configure workspace manager services, functions, and preferences for multimedia device 109, end terminal 111, and/or end terminal 115 using the host 117 via a web browser.

In one embodiment, the workspace manager service is a managed service, whereby a service provider operates the platform 107 to serve one or more subscribers.

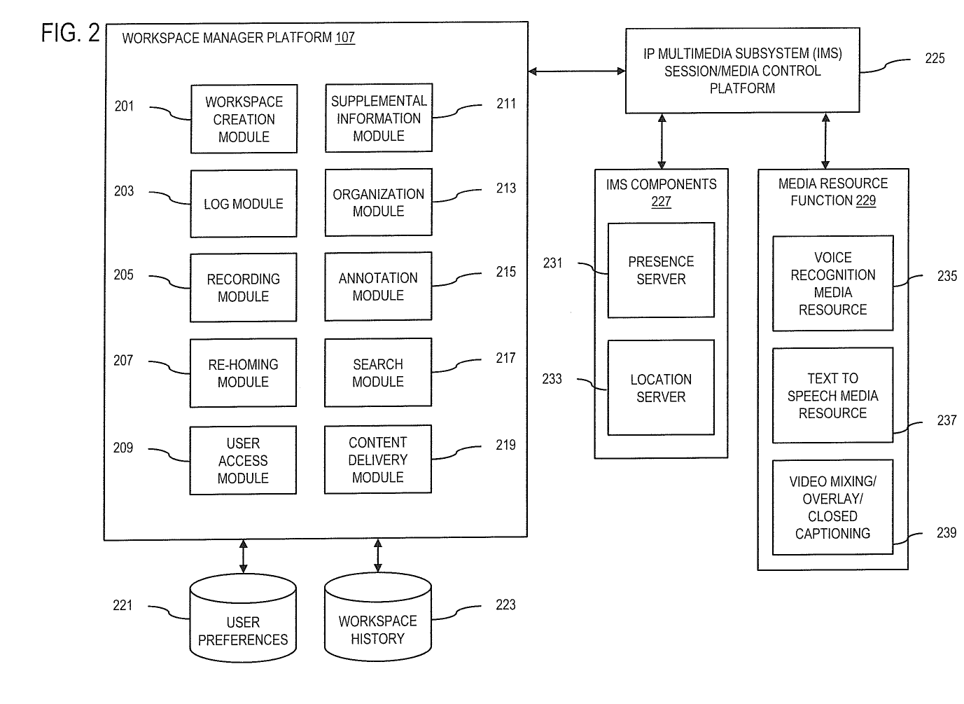

FIG. 2 is a diagram of the components of a workspace manager platform, according to an exemplary embodiment. By way of example, the workspace manager platform 107 may include one or more of the modules to provide logging and storage of communication sessions. A workspace creation module 201 is utilized for creating and defining a workspace. A log module 203 permits logging a user's heterogeneous communication sessions within a workspace; and a recording module 205 records a communication session to the workspace. A re-homing module 207 enables access to a workspace through a user-specified environment (e.g., a specified communication device). Also, a user access module 209 controls access to a workspace. A supplemental information module 211 can obtain additional information (e.g., communication session participants, communication session duration, communication session type, etc.) about a communication session or workspace. An organization module 213 for interacting (e.g., copying, pasting, renaming, etc.) with a workspace.

Further, an annotation module 215 allows users to add notes, comments, and/or attachments to a workspace or communication session. A search module 217 is utilized to conduct searches of a workspace and its contents. A content delivery module 219 for delivering the contents of a workspace to another application.

The workspace manager platform 107 may also have connectivity to a database 221 of user preferences, a database 223 of workspace history, and a media session controller such as an IP Multimedia Subsystem (IMS) session/media control platform 225. The user preferences stored in database 221 may include user settings and configuration information for the workspace manager platform 107 such as whether to automatically record specific communication sessions, types of communication sessions to monitor, and available communication devices. The database 223 of workspace history may include workspaces, recorded communication sessions, supplemental information regarding the communication sessions or workspaces, translations of the communication sessions, and/or other information associated with a workspace or communication session.

In one embodiment, the IMS session/media control platform 225 provides the signaling and communication session controls to invoke the workspace manager platform 107. Specifically, the IMS platform 225 can detect the initiation of a communication session involving a user and direct the communication session to the workspace manager platform 107 for processing. The workspace manager platform 107 then, for instance, may log and store the communication session in the appropriate workspace based on user preferences.

To assist in performing these functions, the IMS platform 225 may include additional IMS components 227 and a media resource function 229. The additional IMS components 227 can assist the workspace manager platform 107 in obtaining supplemental information about a communication session or workspace such as communication session participants, participant contact information, participant locations, time and duration of a communication session, communication session type, associated media (e.g., messages, audio, and video), etc. By way of example, IMS components 227 may include a presence server 231 for determining the presence status of participants in a communication session and a location server 233 for determining their locations. It is contemplated that additional servers, components, and the like may be added to the set of IMS components 227 available to assist the workspace manager platform 107.

Another important function, in certain exemplary embodiments, of the workspace manager platform 107 is the ability to access a workspace of stored communication sessions from any designated communication device regardless of the format of the stored communication sessions. In other words, the workspace manager platform 107 enables a user to “re-home” or move a recorded workspace from one communication device to another. To accomplish this re-homing, the workspace manager platform interacts with, for example, the media resource function 229 of IMS platform 225 to selectively translate a communication session or workspace for presentation on a designated communication device. The media resource function 229 may include a voice recognition media resource 235, a text-to-speech media resource 237, and/or a video mixing/overlay/closed captioning media resource 239 to translate a communication session and output the session in a format suitable for presentation on the designated device or environment.

The voice recognition media resource 235 translates incoming speech into text. Namely, the voice recognition media resource 235 is configured to convert spoken language (analog signal) into textual form (digital signal) by extracting meaning from the user's spoken utterances and producing semantic information in the form of text. The text-to-speech media resource 237 converts text into speech and also can be used to convert meta-data descriptions contained in arriving multimedia streams to speech. The video mixing/overlay/closed captioning resource 239 can present the workspace manager platform 107's output as a textual pop-up window or other form of text output on the display of the user's communication device. If the communication session is video-based (e.g., video communications or multimedia conferencing) or the communication device is video-capable, the resource 239 can insert the workspace manager platform 107's output directly into a video stream that is presented on a specified communication device as a video overlay or as closed captioning.

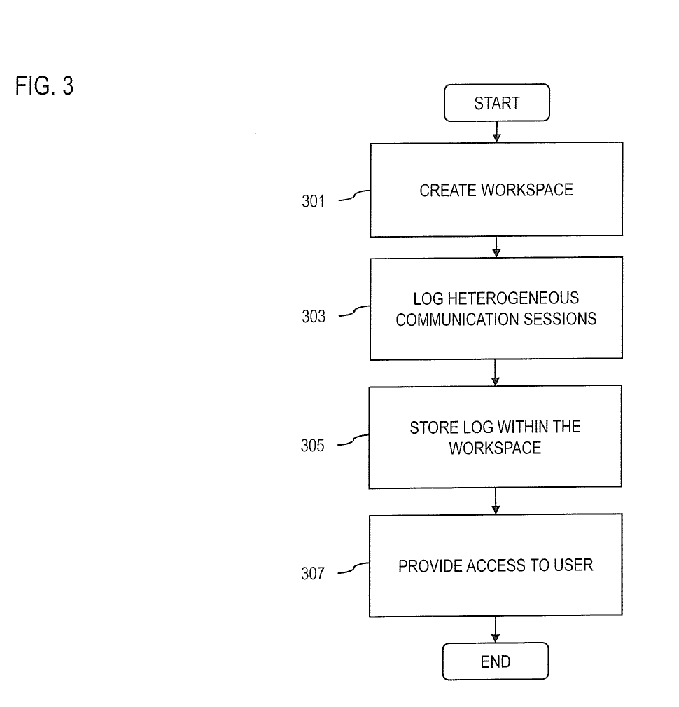

FIG. 3 is a flowchart of a process for creating a workspace and then logging heterogeneous communication sessions within the workspace, according to an exemplary embodiment. In step 301, the workspace manager platform 107 creates a workspace for storing information about a user's communication sessions. A workspace can be, for example, an electronic folder stored in the workspace history database 221. In one embodiment, the workspace creation module 201 of the workspace manager platform 107 may create a default workspace (e.g., a folder named using the current date to store communication sessions conducted by the user on that date) or may create a workspace based on user input. If the workspace is based on user input, the user may specify a name for the workspace at the time of creation. In either case, the workspace manager platform 107 also enables the user to manipulate the workspace (e.g., rename, delete, copy, etc.) at any later point in time.

Once a workspace is created for a particular user, the workspace manager platform 107 begins logging the user's heterogeneous communication sessions per step 303. The logging step 303 begins with the detection of a communication session involving the user. Such detection is independent of the communication device (e.g., multimedia device 109, end terminal 11, or end terminal 115) and may be facilitated by, for instance, the IMS session/media control platform 225. The detection also may be configured to occur either automatically by the IMS platform 225 or manually at the subscriber's command (e.g., after the subscriber enters a key sequence). In certain embodiments, the configuration for the platform's mode of detection may be specified by the subscriber and stored in the user preferences database 221.

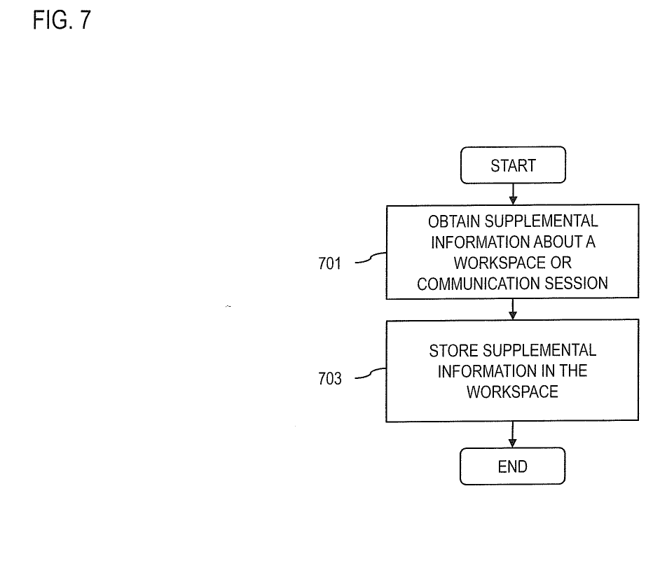

On detection of a communication session, the log module 203 of the workspace manager platform 107 creates a log entry for the communication session for inclusion in the use's communication activity log. The log entry may, for example, include information to identify the communication session such as time of the communication session, communication device, etc. In addition, the log module 203 may include supplemental information in the log entry, as discussed below with respect to FIG. 7. The log module 203 stores the log entry for the communication session within the specified workspace in workspace history database 221 (step 305) and makes the log of communication sessions available for access by the user (step 307). The workspace manager platform 107 will then continue to log additional communication sessions involving the user.

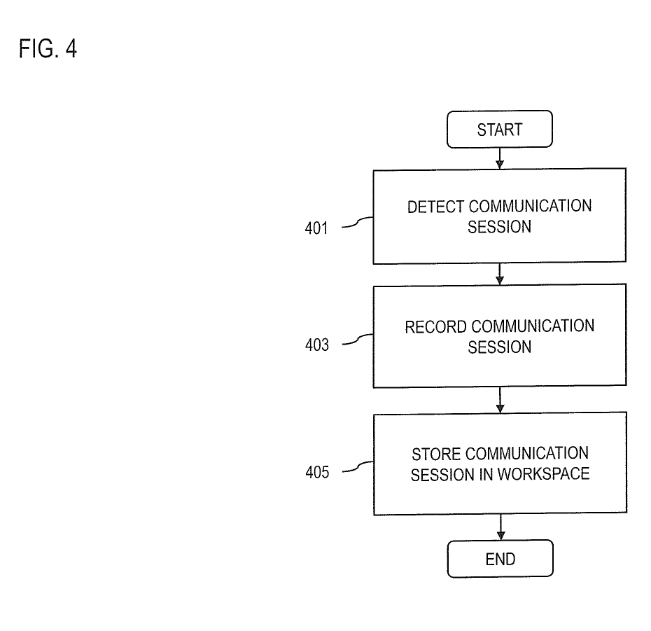

FIG. 4 is a flowchart of a process for recording a communication session to a workspace, according to an exemplary embodiment. The workspace manager platform 107 enables the user to specify whether to record and store a copy of a communication session along with the log entry for the session. The user may specify (for example, during the workspace manager service initiation and provisioning process) that the workspace manager platform 107 should automatically include a recording of one or more types of communication sessions with the corresponding log entries. In addition or alternatively, the user may manually initiate a recording of a specific communication session at the start of the communication session by entering a command, key sequence, or other similar instruction on the user's communication device (e.g., multimedia device 109, end terminal 111, or end terminal 115).

On receiving a command to record a communication session (either automatically or manually), the workspace manager platform 107 will detect the communication session using the IMS platform 225 as described above (step 401). The recording module 205 then initiates recording of the communication session (step 403). The mechanism for recording depends on the type of communication session being conducted. For example, if the communication session involves audio- and/or video-based media, a recording may reproduce the audio/video media as presented during the communication session (i.e., a recording in the traditional sense of the word). If the communication session is text-based (e.g., an instant messaging chat session, text messaging conversation, E-mail), the recording may include a transcript of the session in addition to any attachments exchanged during the session. In one embodiment, the recording module 205 may use the media resource function 229 of the IMS platform 225 to assist in creating the recording. Per step 405, the recording module 205 stores the completed recording within the corresponding workspace in workspace history database 221.

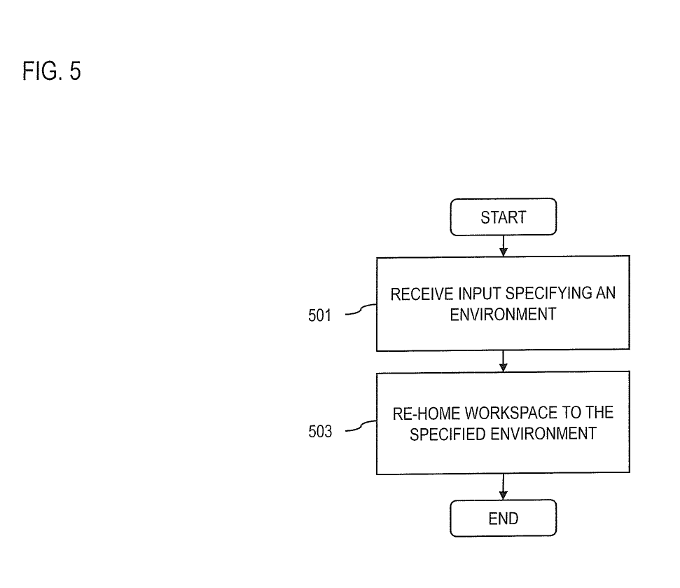

FIG. 5 is a flowchart of a process for re-homing a workspace to an environment specified by the user, according to an exemplary embodiment. In exemplary embodiments, the workspace manager platform 107 may re-home (i.e., move) a workspace and its contents to a user-designated environment (e.g., a communication device such as a home telephone, an office computer, or a mobile telephone) even if the user did not use the environment or device to conduct the original communication session. In step 501, the workspace manager platform 107 receives an input from the user specifying an environment for accessing a workspace. The user can make this input via, for instance, multimedia device 109, end terminal 111, or end terminal 115. In response, the re-homing module 207 in conjunction with the media resource function 229 of the IMS platform 225 selectively converts the workspace and its contents to a format suitable for the specified environment (step 503). To facilitate the conversion process, the media resource function 229 includes a voice recognition media resource 235, a text-to-speech media resource 237, and a video mixing/overlay/closed captioning media resource 239. For example, the re-homing module may use the voice recognition media resource 235 to convert the verbal component of a voice communication session stored within a workspace to text for presentation in an environment or communication device capable of displaying text. Similarly, the re-homing module 207 in conjunction with the media resource function 229 can output a workspace in a visual format (e.g., textual pop-up, video overlay, closed captioning) if the environment or communication device does not allow for audio. It is contemplated that the media resource function 229 may include additional modules to facilitate conversion of a communication session.

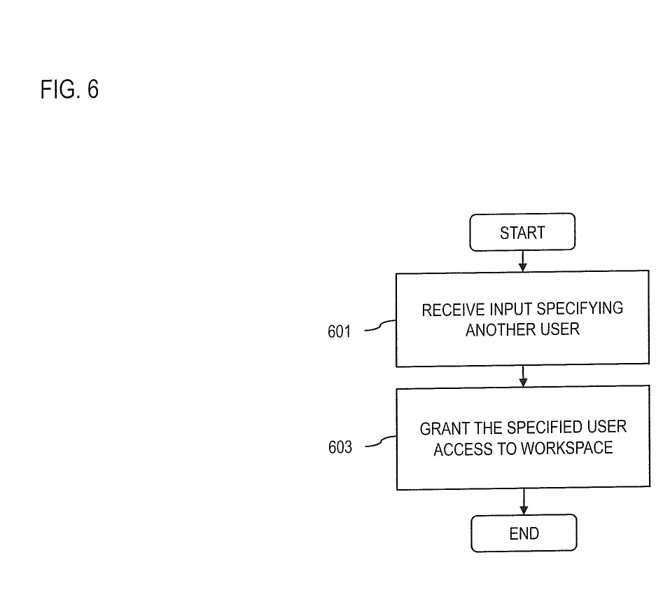

FIG. 6 is a flowchart of a process for allowing access to a workspace by another user, according to an exemplary embodiment. In exemplary embodiments, the workspace manager platform 107 enables a user to allow another user to gain access to a previously created workspace and its contents. To enable this functionality, the user access module 209 of the workspace manager platform 107 receives an input from specifying another user (step 601). The user access module 209 then grants the specified user access to the workspace (step 603) by, for instance, storing the specified user's identity and associated authentication information in the workspace history database 221. When the specified user seeks to access the workspace, the user access module 209 can challenge the user for the previously designated authentication information. It is contemplated that any type of authentication process (e.g., password protection, biometric security) can be employed to ensure that access is provided only to the specified user. It is also contemplated that the workspace manager platform 107 may grant differing levels of access (e.g., read only, full access, access to only certain types of communication sessions, etc.) to the specified user.

FIG. 7 is a flowchart of a process for obtaining supplemental information about a workspace or communication session, according to an exemplary embodiment. Following the completion of a monitored communication session, the workspace manager platform 107 may be configured to obtain supplemental information (e.g., communication session participants, participant contact information, participant locations, time and duration of the communication session, communication session type, and associated media) about the communication session or the associated workspace. In exemplary embodiments, the workspace manager platform 107 may obtain the supplemental information automatically by using network resources (e.g., IMS components 227) or manually from the user (step 701). To obtain the information automatically, the supplemental information module 211 of the workspace manager platform 107 may interact with the IMS components 227 such as the presence server 231 and/or the location server 233. Under this option, the IMS platform 225 may signal the workspace manager platform 107 that a communication session has ended.

The supplemental information module 211 then automatically queries the IMS components 227 for any available supplemental information. In response, the presence server 231 may provide, for instance, information on the parties of the communication session and their communication device capabilities. The location server 233 may also provide information on the location of the parties. In addition (or alternatively), the supplemental information module 211 may obtain some or all of the supplemental information by presenting the user with the option to manually enter the supplemental information. The supplemental information module 211 then stores the information within the appropriate workspace in the workspace history database 223 (step 703).

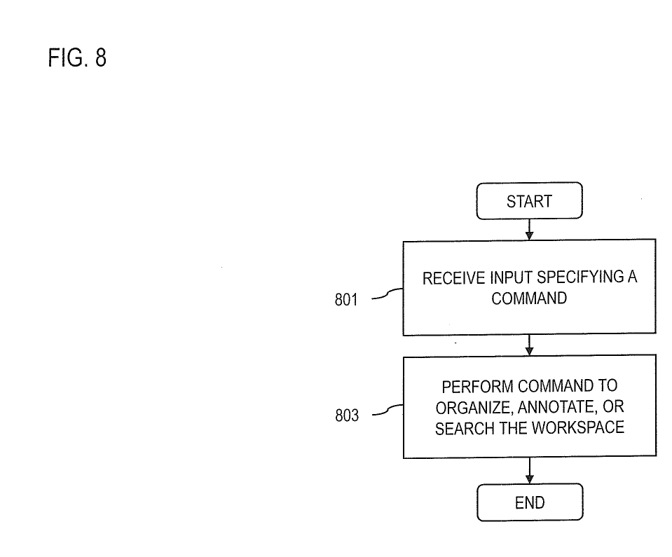

FIG. 8 is a flowchart of a process for receiving a command from a user to organize, annotate, or search a workspace, according to an exemplary embodiment. In step 801, the workspace manager receives an input from a user specifying a workspace command. The user may enter the command via, for example, multimedia device 109, end terminal 111, or end terminal 115. The input may include a command to organize a workspace, annotate a workspace, or search a workspace. It is contemplated that the workspace manager platform 107 may be extended to include additional commands for user interaction with a workspace. Following receipt of the input, the workspace manager platform 107 performs the requested command per, step 803. More specifically, the workspace manager platform 107 may employ one of three modules (i.e., an organization module 213, an annotation module 215, and a search module 217) to perform the functions.

The organization module 213 enables a user to copy, paste, rename, delete, move, merge, and sort both the workspace as well as the information stored within the workspace. For example, the user may move a communication session recorded within one workspace to another more appropriate workspace or delete the communication session altogether. It is contemplated that other organization-related commands and functions may be added to the organization module 213.

The annotation module 215 enables the user to add notes, comments, and/or other attachments to a workspace or a specific communication session logged or stored within the workspace. The annotations then become a part of the workspace and are accessible by the user.

The search module 217 enables a user to search the information stored within one or more of the user's workspaces including the communication session logs, recorded communication sessions, supplemental information, and annotations. To provide this functionality, the search module 217 may use the media resource function 229 to convert any non-textual information stored within the workspace or workspaces into textual information. As discussed with respect to the re-homing module 207 above, the voice recognition media resource 235 may convert communication sessions or information that is stored as spoken language into textual information. The search module 217 may then scan the converted textual information for a text string specified by the user and present the search results to the user. In exemplary embodiments, it is contemplated that the user may limit searches according to various criteria (e.g., by workspace, by time, by communication type, by participant, etc.).

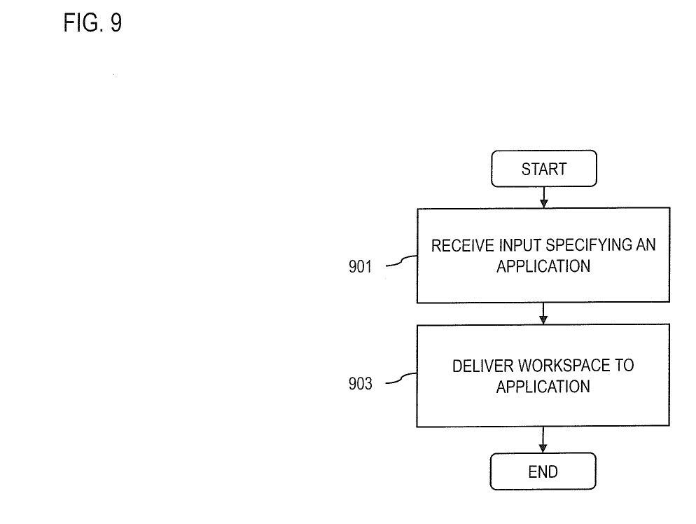

FIG. 9 is a flowchart of a process for delivering a workspace to an application, according to an exemplary embodiment. In exemplary embodiments, the workspace manager platform 107 may be configured to deliver a workspace and its contents to another application. In this way, the user may leverage the information contained within a workspace for use in other applications (e.g., calendar applications, personal web portals, contact management applications, etc.). In step 901, the workspace manager platform 107 receives an input specifying an application to which a workspace should be delivered. The input may be made directly by a user or by an application on behalf of the user. In response to the input, the content delivery module 219 of the workspace manager platform 107 may verify the authentication credentials of the requesting user or application. As discussed with respect to the user access module 209, it is contemplated that any suitable authentication process may be used to verify that a user or application is authorized to request the delivery of a workspace.

Following authentication, the content delivery module 219 delivers the requested workspace to the application by, for instance, a content syndication protocol such as Really Simple Syndication (RSS) (step 903). To assist in the delivery, the content delivery module 219 may use the media resource function 229 to convert any non-textual information stored in the workspace into textual information for delivery using the content syndication protocol. For example, a content delivery module 219 may deliver a workspace as an RSS feed and/or use an RSS widget to integrate the workspace content into a personal web page. Other applications such as personal information manager or contact management application may also use information provided by the workspace RSS feed.

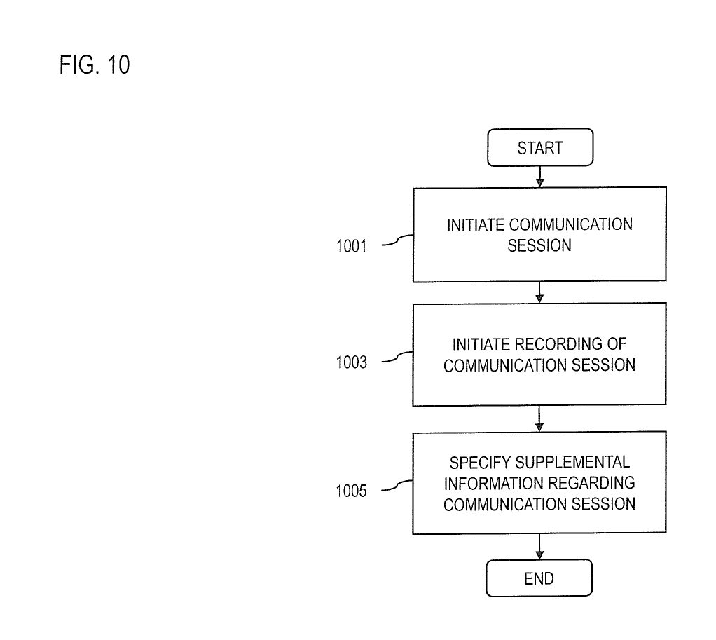

FIG. 10 is a flowchart of a process for using the workspace manager to record a communication session to a workspace from a user's perspective, according to an exemplary embodiment. This process assumes that the user has already setup the workspace manager service. In step 1001, a communication session involving the user is initiated by using, for example, multimedia device 109, end terminal 111, or end terminal 115. The session may either be initiated by the user or be initiated by another party and directed to the user. During the communication session, the user may manually instruct the workspace manager platform 107 to record the communication session in a workspace by, for instance, entering a command or key sequence into the user's communication device (step 1003).

In exemplary embodiments, the user also has the option to instruct the workspace manager platform 107 to automatically record the communication session. When the user has completed the communication session, the user may enter supplemental information or annotate the communication session for later reference (step 1005). It is contemplated that the user may enter the supplemental information or annotations immediately after the communication session or at any later time.

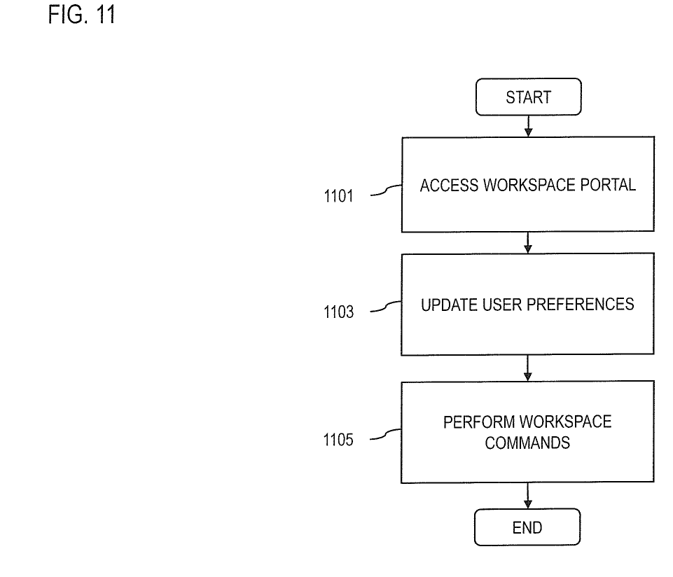

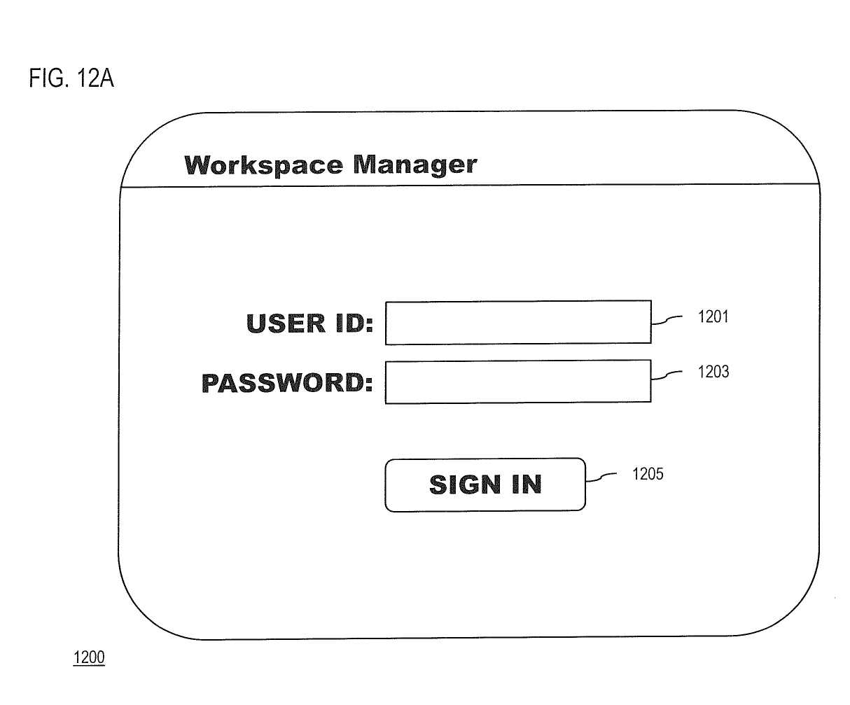

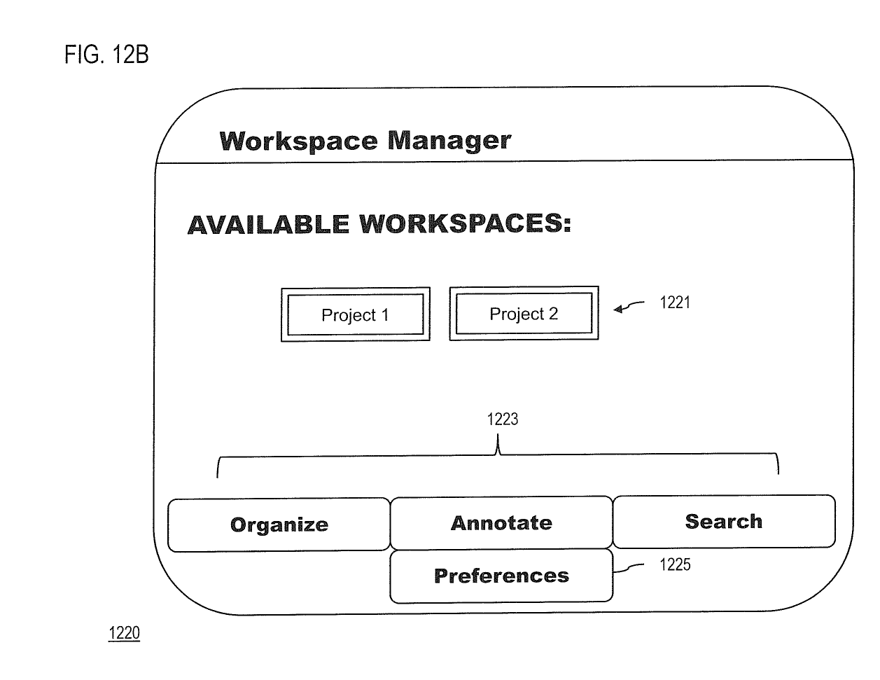

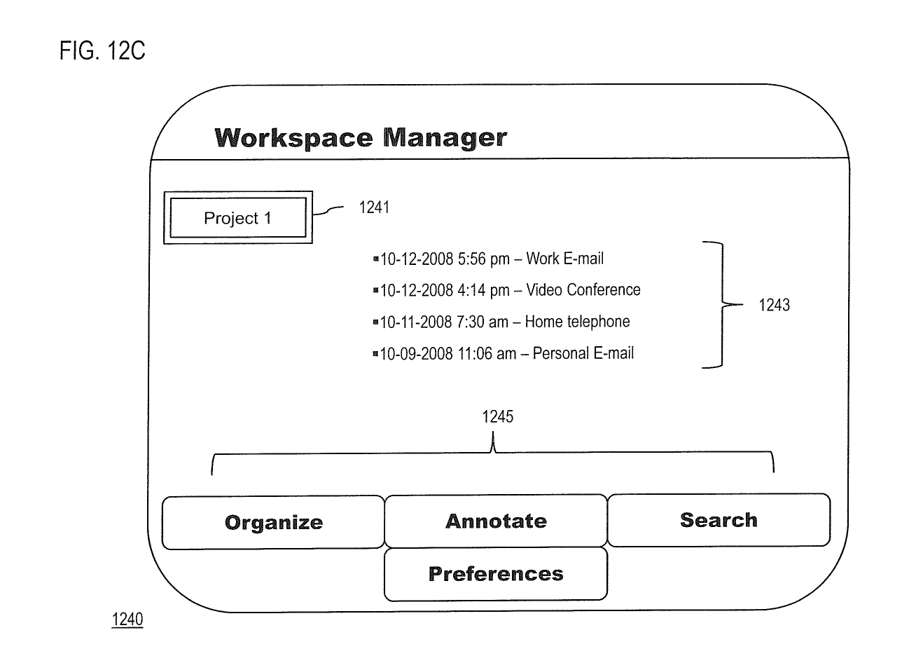

FIG. 11 is a flowchart of a process for using a portal to access the functions of the workspace manager from a user's perspective, according to an exemplary embodiment. This process is also described with respect to FIGS. 12A-12C which depict exemplary graphical user interfaces for using a portal to access the functions of the workspace manager, according to various embodiments of the present invention. As previously mentioned, the workspace manager platform 107 has connectivity to a host 117 that enables access to workspace manager platform 107 functions and preferences via a graphical user interface or a web-based application. A user may access the graphical user interface portal using multimedia device 109, end terminal 111, or end terminal 115 (step 1101 of FIG. 11). In exemplary embodiments, the user provides authentication credentials (e.g., password, biometric security) to access the services of the workspace manager platform 107. User interface 1200 of FIG. 12A depicts an exemplary user interface screen that requests a user ID 1201 and password 1203 from the user. The user enters the requested user ID and password and clicks on the “Sign In” button 1205 to proceed.

After entering valid authentication credentials, the user may access the portal to update user preferences (step 1103 of FIG. 11) and/or perform workspace commands (step 1105 of FIG. 11). User interface 1220 of FIG. 12B depicts an exemplary user interface screen that lists available workspaces 1221, available commands 1223, and a button 1225 to access user preferences. The user may update user preferences by selecting the user preferences button 1225. The user will then be able to update settings and configurations for the workspace manager platform 107 such as whether to automatically record specific communication sessions, types of communication sessions to monitor, available communication devices, etc. The user also may select any of the workspace commands 1223 to organize, annotate, or search a workspace.

By selecting one of the available workspaces 1221, the user may access the communication sessions and information stored within the workspace. User interface 1240 of FIG. 12C depicts an exemplary screen for displaying the contents of a workspace. The screen lists the name of the workspace 1241 and provides a log 1243 of the communication sessions stored within the workspace. The user may access any available supplemental information or recording of the communication session by selecting the desired entry on the log. The user also may perform a workspace command by selecting one of the command buttons 1245.

The processes described herein for providing a workspace to log and/or store multiple heterogeneous communication sessions may be implemented via software, hardware (e.g., general processor, Digital Signal Processing (DSP) chip, an Application Specific Integrated Circuit (ASTC), Field Programmable Gate Arrays (FPGAs), etc.), firmware or a combination thereof. Such exemplary hardware for performing the described functions is detailed below.

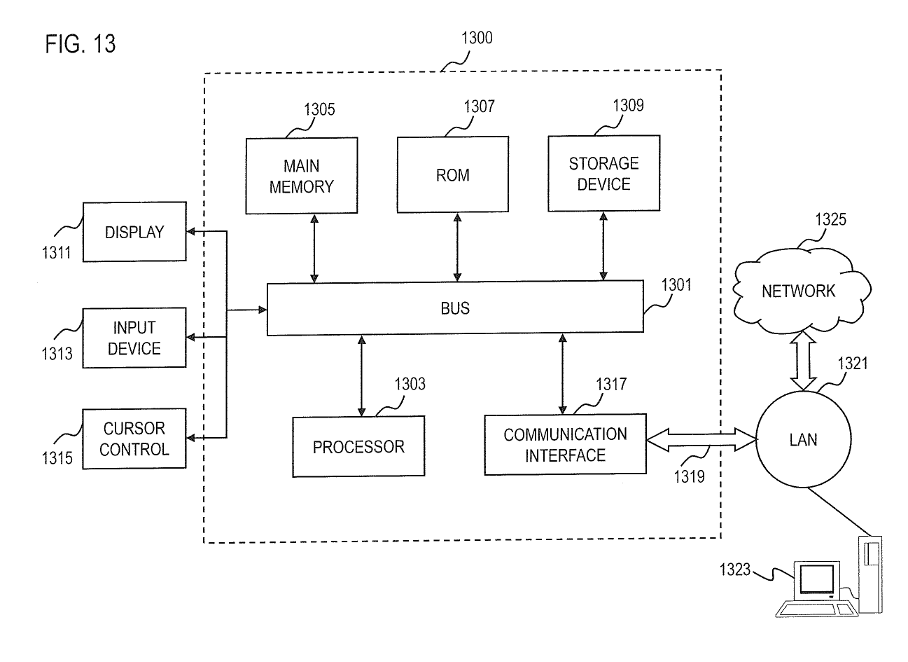

FIG. 13 illustrates computing hardware (e.g., computer system) upon which an embodiment according to the invention can be implemented. The computer system 1300 includes a bus 1301 or other communication mechanism for communicating information and a processor 1303 coupled to the bus 1301 for processing information. The computer system 1300 also includes main memory 1305, such as random access memory (RAM) or other dynamic storage device, coupled to the bus 1301 for storing information and instructions to be executed by the processor 1303. Main memory 1305 also can be used for storing temporary variables or other intermediate information during execution of instructions by the processor 1303. The computer system 1300 may further include a read only memory (ROM) 1307 or other static storage device coupled to the bus 1301 for storing static information and instructions for the processor 1303. A storage device 1309, such as a magnetic disk or optical disk, is coupled to the bus 1301 for persistently storing information and instructions.

The computer system 1300 may be coupled via the bus 1301 to a display 1311, such as a cathode ray tube (CRT), liquid crystal display, active matrix display, or plasma display, for displaying information to a computer user. An input device 1313, such as a keyboard including alphanumeric and other keys, is coupled to the bus 1301 for communicating information and command selections to the processor 1303. Another type of user input device is a cursor control 1315, such as a mouse, a trackball, or cursor direction keys, for communicating direction information and command selections to the processor 1303 and for controlling cursor movement on the display 1311.

According to an embodiment of the invention, the processes described herein are performed by the computer system 1300, in response to the processor 1303 executing an arrangement of instructions contained in main memory 1305. Such instructions can be read into main memory 1305 from another computer-readable medium, such as the storage device 1309. Execution of the arrangement of instructions contained in main memory 1305 causes the processor 1303 to perform the process steps described herein. One or more processors in a multi-processing arrangement may also be employed to execute the instructions contained in main memory 1305. In alternative embodiments, hard-wired circuitry may be used in place of or in combination with software instructions to implement the embodiment of the invention. Thus, embodiments of the invention are not limited to any specific combination of hardware circuitry and software.

The computer system 1300 also includes a communication interface 1317 coupled to bus 1301. The communication interface 1317 provides a two-way data communication coupling to a network link 1319 connected to a local network 1321. For example, the communication interface 1317 may be a digital subscriber line (DSL) card or modem, an integrated services digital network (ISDN) card, a cable modem, a telephone modem, or any other communication interface to provide a data communication connection to a corresponding type of communication line. As another example, communication interface 1317 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1317 sends and receives electrical, electromagnetic, or optical signals that carry digital data streams representing various types of information. Further, the communication interface 1317 can include peripheral interface devices, such as a Universal Serial Bus (USB) interface, a PCMCIA (Personal Computer Memory Card International Association) interface, etc. Although a single communication interface 1317 is depicted in FIG. 13, multiple communication interfaces can also be employed.

The network link 1319 typically provides data communication through one or more networks to other data devices. For example, the network link 1319 may provide a connection through local network 1321 to a host computer 1323, which has connectivity to a network 1325 (e.g. a wide area network (WAN) or the global packet data communication network now commonly referred to as the “Internet”) or to data equipment operated by a service provider. The local network 1321 and the network 1325 both use electrical, electromagnetic, or optical signals to convey information and instructions. The signals through the various networks and the signals on the network link 1319 and through the communication interface 1317, which communicate digital data with the computer system 1300, are exemplary forms of carrier waves bearing the information and instructions.

The computer system 1300 can send messages and receive data, including program code, through the network(s), the network link 1319, and the communication interface 1317. In the Internet example, a server (not shown) might transmit requested code belonging to an application program for implementing an embodiment of the invention through the network 1325, the local network 1321 and the communication interface 1317. The processor 1303 may execute the transmitted code while being received and/or store the code in the storage device 1309, or other non-volatile storage for later execution. In this manner, the computer system 1300 may obtain application code in the form of a carrier wave.

The term “computer-readable medium” as used herein refers to any medium that participates in providing instructions to the processor 1303 for execution. Such a medium may take many forms, including but not limited to non-volatile media, volatile media, and transmission media. Non-volatile media include, for example, optical or magnetic disks, such as the storage device 1309. Volatile media include dynamic memory, such as main memory 1305. Transmission media include coaxial cables, copper wire and fiber optics, including the wires that comprise the bus 1301. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
creating a workspace for a user;
logging a plurality of heterogeneous communication sessions conducted by the user as a communication activity log; and
storing the log within the workspace for access by the user.

2. A method of claim 1, wherein the heterogeneous communication sessions include at least one of a voice communication, a text-based communication, a video communication, multimedia conferencing, or a combination thereof, and the communication sessions are conducted by the user using different communication devices.

3. A method of claim 1, wherein the workspace is defined by the user.

4. A method of claim 1, further comprising:
detecting establishment of one of the communication sessions;
recording the one communication session based on the detection; and
storing the recorded communication session in the workspace.

5. A method of claim 1, further comprising:
re-homing the workspace to an environment specified by the user.

6. A method of claim 1, further comprising:
allowing access to the workspace by another user.

7. A method of claim 1, further comprising:
obtaining supplemental information associated with the communication session or the workspace; and
storing the supplemental information within the workspace.

8. A method of claim 7, wherein the supplemental information includes communication session participants, participant contact information, participant presence status, participant locations, time and duration of the communication session, communication session type, associated media, and/or user-created annotations.

9. A method of claim 1, further comprising:
receiving a command from the user for invoking, in response to the command, at least one of,
organizing the workspace,
annotating the workspace, or
searching the workspace.

10. A method of claim 1, further comprising:
delivering the workspace to an application using a content syndication protocol.

11. A method of claim 10, wherein the content syndication protocol includes a Really Simple Syndication protocol.

12. An apparatus comprising:
a workspace creation module configured to create a workspace for a user;
a logging module configured to log a plurality of heterogeneous communication sessions conducted by the user as a communication activity log; and
a database configured to store the log within the workspace for access by the user.

13. An apparatus of claim 12, wherein the heterogeneous communication sessions include at least one of a voice communication, a text-based communication, a video communication, multimedia conferencing, or a combination thereof, and the communication sessions are conducted by the user using different communication devices.

14. An apparatus of claim 12, wherein the workspace is defined by the user.

15. An apparatus of claim 12, further comprising:
a recording module configured to detect establishment of one of the communication sessions and to record the one communication session based on the detection, wherein the recorded communication session is stored in the workspace.

16. An apparatus of claim 12, further comprising:
a re-homing module configured to re-home the workspace to an environment specified by the user.

17. An apparatus of claim 12, further comprising:
a user access module configured to allow access to the workspace by another user.

18. An apparatus of claim 12, further comprising:
a supplemental information module configured to obtain supplemental information associated with the workspace, wherein the supplemental information is stored within the workspace.

19. An apparatus of claim 18, wherein the supplemental information includes communication session participants, participant contact information, participant presence status, participant locations, communication session duration, communication session type, associated media, and/or user-created annotations.

20. An apparatus of claim 12, wherein a command is received from the user for invoking, in response to the command, at least one of,
an organization module to organize the workspace,
a supplemental information module configured to permit annotation of the workspace, or
a search module configured to search the workspace.

21. An apparatus of claim 12, further comprising:
delivering the workspace to an application using a content syndication protocol.

22. An apparatus of claim 21, wherein the content syndication protocol includes a Really Simple Syndication protocol.

23. A system comprising:
a workspace manager configured to create an electronic folder for a subscriber,
wherein the workspace manager is coupled to a multimedia system configured to communicate with a plurality of different communication devices corresponding to the subscriber,
wherein the workspace manager is further configured to log a plurality of heterogeneous communication sessions established using one or more of the communication devices within the electronic folder for access by the subscriber.

24. A system of claim 22, further comprising:
creating another electronic folder for the subscriber, wherein the electronic folders are defined by the subscriber.
